(19) United States
(12) Patent Application Publication
(10) Pub. No.: US 2012/0105460 A1
(43) Pub. Date: May 3, 2012

(54) MOBILE TERMINAL FOR DISPLAYING ELECTRONIC BOOK AND METHOD THEREOF

(75) Inventor: Joo Sub KIM, Gyeongsangbuk-do (KR)

(73) Assignee: SAMSUNG ELECTRONICS CO., LTD., Gyeonggi-Do (KR)

(21) Appl. No.: 13/282,739

(22) Filed: Oct. 27, 2011

(30) Foreign Application Priority Data
Oct. 29, 2010 (KR) 10-2010-0106578

(51) Int. Cl. G06T 1/00

(52) U.S. Cl. 345/501

(57) ABSTRACT

The present invention relates to a mobile terminal for displaying an e-book and a method thereof. The e-book content is displayed at a preset time point specified in an e-book profile, linking received e-book supplementary information to the e-book profile and storing the e-book supplementary information, and updating, when the e-book is terminated, the e-book profile to include current internal location information of the e-book content to be used for displaying the e-book content next time. The present invention provides an advantage that the e-book is displayed automatically to enable a user to use the e-book conveniently and at different location without any interruption. The present invention also provides convenience of providing supplemental material to previous programs and prevents users from any learning interruptions during operation of the e-book.

### CLAIM OF PRIORITY

This application claims the benefit under 35 U.S.C. §119 of a Korean Patent Application filed in the Korean Intellectual Property Office on Oct. 29, 2010 and assigned Serial No. 10-2010-0106578, the entire disclosure of which is hereby incorporated by reference.

### BACKGROUND OF THE INVENTION

1. Field of the Invention

The present invention relates to a mobile terminal for displaying an electronic book (hereinafter referred to as “e-book”) and a method thereof.

2. Description of the Related Art

Recently, the number of Internet users is increasing even more rapidly due to an extensive and continued information infrastructure and improvement in the communication environment. In concert with this trend, various commercial transactions and distribution of e-books through the Internet has become popular over the paper books.

An e-book provides text content and image-based publication in digital form for general reading as well as in lectures, seminars or meetings. In such cases, e-books are used in different places. Therefore, a user may experience inconvenience in cases when he or she must search for a desired e-book content that may be time specific.

As a result, there is a need for a method of displaying the content of an e-book more conveniently.

### SUMMARY OF THE INVENTION

The present invention has been made in view of the above problems and provides additional advantages, by providing a mobile terminal that may display an e-book content by linking timetable information and e-book information, such that the e-book content that may be time dependent or prescheduled can be automatically displayed and continually displayed as the content is accessed over different time periods.

The present invention also provides supplementary materials and learning materials relating to previous content/classes together with the e-book content so that it can enhance and provide conveniences for education purposes. In addition, the present invention is able to provide a reception of specific information to avoid any interruption thus enabling the user to concentrate on learning of the e-book content during operation.

In accordance with another aspect of the present invention, a method of displaying an e-book content includes displaying the e-book at a set time point according to an e-book profile, linking received e-book supplementary information to the e-book profile and storing the e-book supplementary information, and updating, when displaying the e-book is terminated, the e-book profile to comprise internal location information of the e-book to be used for a continual displaying of the e-book content at later time without interruption.

In accordance with another aspect of the present invention, a mobile terminal for displaying an e-book content includes a display unit for displaying the e-book content, a storage unit for storing e-book information comprising the e-book content, timetable information comprising a preset time point and an e-book profile linking the e-book information and the timetable information, and an e-book control unit for controlling the display unit to display the e-book at the preset time point according to the time specified in the e-book profile, to link received e-book supplementary information to the e-book profile and store the e-book supplementary information, and to update, when displaying the e-book is terminated, the e-book profile to comprise current internal location information of the e-book content to be used for displaying of the e-book content at another time/location.

### BRIEF DESCRIPTION OF THE DRAWINGS

The features and advantages of the present invention will be more apparent from the following detailed description in conjunction with the accompanying drawings, in which:

FIG. 1 is a block diagram illustrating a schematic configuration of a mobile terminal according to an exemplary embodiment of the present invention; and

FIG. 2 is a flow chart illustrating a method of displaying an e-book according to an exemplary embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

In the description, the term “timetable information” refers to information relating to a schedule, which may include time, geographical location, title of the scheduled program and the like. The term “e-book information” refers to information including an e-book and e-book-related information such as an author, publishing company, International Standard Book Number (ISBN) bar code and the like. The timetable information may be preset, and the e-book information may be downloaded or pre-stored.

The present invention relates to a method of displaying an e-book content, and may be embodied when a mobile terminal performs (1) a registration mode, (2) standby mode, (3) use mode, or (4) termination mode.

The registration mode according to an exemplary embodiment of the present invention represents a mode for storing an e-book profile by linking timetable information and e-book information in the mobile terminal which will be described later.

During the standby mode, the e-book determines an e-book display time point to determine the exact time when the e-book content is to be displayed by incorporating difference in time location.

During the use mode, the mobile terminal may display an e-book content and receive e-book supplementary information.

The termination mode starts when use of the e-book is terminated in the mobile terminal. The termination mode includes updating an e-book profile in the mobile terminal and terminating the e-book after updating.

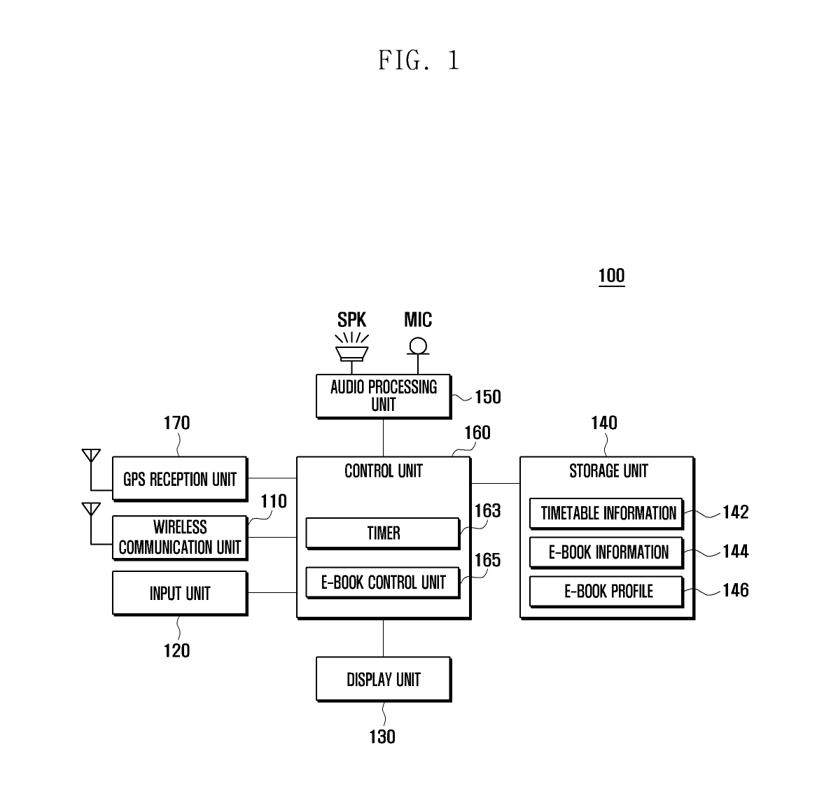

FIG. 1 is a block diagram illustrating a schematic configuration of a mobile terminal according to an exemplary embodiment of the present invention.

Referring to FIG. 1, a mobile terminal 100 includes a wireless communication unit 110, input unit 120, display unit 130, storage unit 140, audio processing unit 150, control unit 160, and GPS (Global Positioning System) reception unit 170.

The mobile terminal 100 may preferably be any information communication device and multimedia device, such as a mobile phone, wired/wireless phone, PDA (personal digital assistant), smart phone, DMB terminal, notebook (laptop) and personal computer, GSM (Global System For Mobile Communication)/GPRS (General Packet Radio System) terminal, and 3G terminal including an IMT-2000(International Mobile Telecommunication 2000) terminal and UMTS (Universal Mobile Telecommunication Service) terminal utilizing WCDMA (Wideband Code Division Multiple Access) technology, and applications thereof. Specifically, the mobile terminal 100 according to the present invention includes timetable information 142 and displays an e-book content from e-book information 144 according to the time specified in the time table information 142.

The wireless communication unit 110 performs a wireless communication function of the mobile terminal 100. The wireless communication unit 110 includes an RF transmitter for upconverting a frequency of a signal to be transmitted and amplifying the signal, and an RF receiver for low-noise amplifying a received signal and downconverting a frequency of the signal. Specifically, the wireless communication unit 110 according to an exemplary embodiment of the present invention may access a web server according to control of the control unit 160 and may download the e-book information 144 and timetable information 142.

The input unit 120 receives input of numeral and character information as well as information for setting various functions, and transmits the input information to the control unit 160. The input unit 120 may include numeral keys, character keys, directional keys set to perform specific functions, function keys such as side keys and shortcut keys, and a touch pad.

The display unit 130 displays a state of the mobile terminal 100. Specifically, the display unit 130 according to an exemplary embodiment of the present invention displays the content of an e-book. Additionally, the display unit 130 may be embodied with electronic ink (e-ink). The e-ink is an e-book display technology known to persons having ordinary skill in the art which uses low electric power, provides a wider view, and shows texture similar to a paper book.

The storage unit 140 comprises a program memory and data memory. In accordance with an exemplary embodiment of the present invention, the program memory stores an operation program of the mobile terminal 100, an e-book control program for displaying the e-book content according to the time scheduled in the e-book profile 146, an e-book viewer program for displaying the e-book, and a timetable program for controlling and storing the timetable information 142. The data memory stores data used or created while aforementioned programs are executed.

Specifically, the storage unit 140 of the present invention stores the timetable information 142, e-book information 144, and e-book profile 146 according to control of the control unit 160. The e-book profile 146 is generated via linking of information between the timetable information 142 and e-book information 144. Additionally, the e-book profile 146 may further include e-book use history information, such as internal location information of the e-book (for example, a displayed page number, such as Page 50), and time and geographical location when a termination mode is entered.

The storage unit 140 according to an exemplary embodiment of the present invention may buffer and store e-book supplementary information received during display of the e-book. The e-book supplementary information may be a memo, note, an image, recorded audio, video or electronic documents. The buffered e-book supplementary information may be stored in the e-book profile 146 or separately from the e-book profile 146 in the storage unit 140.

The audio processing unit 150 generates an audio signal output from an audio CODEC through a speaker (SPK), and transmits an audio signal input through a microphone (MIC) to the audio CODEC. Specifically, the microphone according to an exemplary embodiment of the present invention may collect contents of learning materials, a seminar or a meeting by control of the control unit 160.

The control unit 160 controls overall operation of the mobile terminal 100. Specifically, the control unit 160 of the present invention includes a timer 163 and an e-book control unit 165. The timer 163 is used to measure the current time. The e-book control unit 165 controls an e-book display time point and the e-book profile 146 to display the e-book content according to the e-book profile 146.

Specifically, the e-book control unit 165 accesses the timetable information 142 in a registration mode. The e-book control unit 165 creates the e-book profile 146 by linking the timetable information 142 and the e-book information 144, and stores the e-book profile 146 in the storage unit 140. The e-book control unit 165 determines an e-book display time point in a standby mode. The e-book control unit 165 determines the e-book display time point by comparing the current time measured by the timer 163 and the e-book profile 146. Alternatively, the e-book control unit 165 may determine an e-book display time point with reference to the current geographical location identified by the GPS reception unit 170. By determining the e-book display time point as described above, the e-book control unit 165 controls the display unit 130 to display the e-book automatically at the scheduled time. The e-book control unit 165 may control e-book supplementary information to be buffered in the storage unit 140, that is, information received from various functioning parts of the mobile terminal 100 such as the input unit 120, audio processing unit 150, camera (not shown), and wireless communication unit 110 in a use mode.

Additionally, the e-book control unit 165 may control the buffered e-book supplementary information to be stored with a link to the e-book profile 146 during the use mode for a subsequent review.

The e-book control unit 165 may update the e-book profile 146 during a termination mode. When the e-book content is displayed next time, the updated e-book profile 146 may be controlled by the e-book control unit 165 to display a page that was displayed prior to the termination, thus providing a continual review of the content without interruption. Therefore, the present invention provides an advantage in that the user does not need to remember the last page number in the learning material.

The GPS reception unit 170 receives information on the current geographical location of the mobile terminal 100, such as the latitude and longitude, from a GPS satellite under control of the control unit 160.

The mobile terminal 100 according to an exemplary embodiment of the present invention may further include a camera. The camera may be installed in the mobile terminal 100 or connected to the mobile terminal 100, and may capture a still image or moving image according to a command from the user input through the input unit 120.

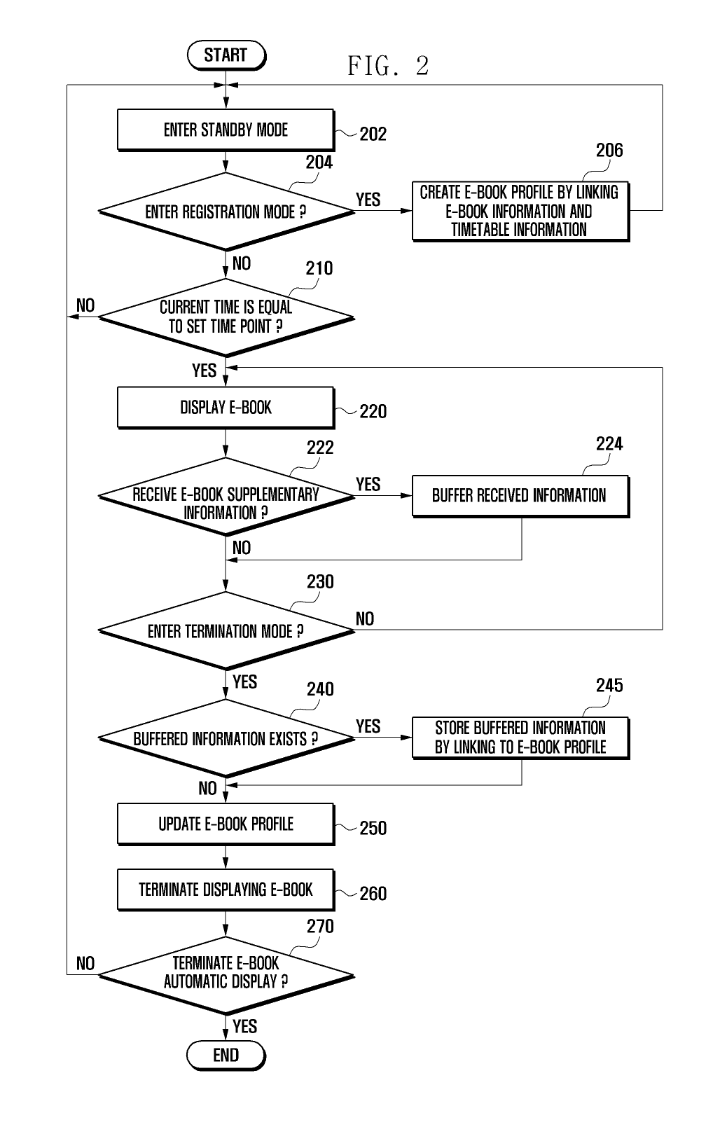

FIG. 2 is a flow chart illustrating a method of displaying an e-book according to an exemplary embodiment of the present invention.

Referring to FIG. 2, a method of displaying an e-book according to an exemplary embodiment of the present invention starts, on the assumption that a predetermined e-book profile 146 is pre-stored in the storage unit 140 during a standby mode (202). The e-book control unit 165 determines whether a registration mode is entered (204) to generate or update the e-book profile.

If a registration mode is requested, the e-book control unit 165 performs step 206. Here, the e-book control unit 165 creates the e-book profile 146 by linking the e-book information 144 and timetable information 142 and then storing the e-book profile 146 in the storage unit 140 (206). When the e-book profile 146 is created, the e-book control unit 165 may link the e-book information 144 and the timetable information 142 according to a different set time requested from the user.

An example of step 206 is described hereinafter. Table 1 shows an example of timetable information 142, Table 2 shows an example of e-book information 144, and Table 3 shows an example of e-book profile 146, which is created by linking information of Table 1 and that in Table 2. If a schedule of a lecture on software design is set as shown in Table 1, the e-book control unit 165 may enable the user to select the e-book information 144 that corresponds to the timetable information 142 from the entire e-book information 144 stored in the storage unit 140. A geographical location is selectively included in the timetable information 142 as described below.

TABLE 1

| Timetable information identifier | Content |
|---|---|
| Timetable information title | Lecture on software design |
| Time | Every Tuesday and Thursday, |
| | 15:30-17:00 from September to |
| | December, 2010 |
| Geographical location | MC Room No. 1050 |

TABLE 2

| E-book information identifier | Content |
|---|---|
| E-book title | Introduction to the Design & |
| | Analysis of Algorithms |
| Author | Levitin |
| Publishing company | Addison Wesley |
| ISBN bar code | 978-0321358288 |

TABLE 3

| E-book profile identifier | |
|---|---|
| E-book title | Introduction to the Design & |
| | Analysis of Algorithms |
| Timetable information title | Lecture on software design |

Further to the example described above, multiple timetable information 142 may be linked to one e-book information 144, or multiple e-book information 144 may be linked to one timetable information 142. The e-book profile 146 includes at least one identifier of the timetable information 142 and at least one identifier of the e-book information 144.

In an alternate embodiment, the e-book control unit 165 may create the e-book profile 146 automatically even if there is no request from a user. For example, the e-book control unit 165 may determine whether an e-book profile 146 of the e-book displayed in a termination mode exists. If the e-book profile 146 is determined not to exist, the e-book control unit 165 may access the timetable information 142 and determine whether timetable information 142 corresponding to the current time or geographical location exists. If such timetable information 142 exists, the e-book control unit 165 may create an e-book profile 146 automatically by linking the displayed e-book and the determined timetable information 142. If such timetable information 142 is determined not to exist, the e-book control unit 165 may create an e-book profile 146 by requesting an input from the user.

After performing step 206, the e-book control unit 165 controls to return to the standby mode of step 202. Thereafter, the e-book control unit 165 controls to automatically display the e-book content at a preset time. Thus, if a registration mode is determined not to be entered in step 204, the e-book control unit 165 performs step 210. The e-book control unit 165 determines whether a time point set according to the e-book profile 146 has been reached (210). Specifically, the e-book control unit 165 controls the timer 163 to determine the current time. The e-book control unit 165 then identifies timetable information 142 corresponding to each of the e-book information 144. If a set time point is included in the e-book profile 146, the e-book control unit 165 accesses the e-book profile 146 stored in the storage unit 140 to identify set time points. On the other hand, if a set time point is not included in the e-book profile 146, as in Table 3, the e-book control unit 165 accesses the timetable information 142 according to the e-book profile 146 by using an identifier of the timetable information 142 such as a title in the timetable information 142, and identifies a set time point corresponding to the e-book information 144. Then, the e-book control unit 165 compares the determined current time and set time points, and determines whether the determined current time is equal to one of the set time points in step 210.

If at least one set time point is equal to the determined current time in step 210, the e-book control unit 165 determines that the set time point has been reached, and performs step 220 during the use mode. According to an exemplary embodiment of the present invention, if the difference between the determined current time and any of the set time points is less than a preset time difference, it may be determined that the determined current time is equal to the set time point. If the determined current time is not equal to at least one of the set time points, the e-book control unit 165 controls the process to return to the standby mode of step 202.

Additionally, after the set time point is determined to be reached, a method according to an exemplary embodiment of the present invention may further include comparing the current geographical location identified through the GPS reception unit 170 with a set geographical location of the timetable information 142 according to the e-book profile 146 and determining whether they are identical. If the current geographical location is further determined to be identical to the set geographical location after the set time point is determined to be reached, the e-book control unit 165 may control to perform step 220. If the current geographical location is determined to be within a specific distance of the set geographical location according to setting by the user during the comparing of the current geographical location and a set geographical location according to the e-book profile 146, the e-book control unit 165 may determine that the current geographical location is identical to the set geographical location.

The e-book control unit 165 controls the display unit 130 to display an e-book at a preset time point (220). Specifically, the e-book control unit 165 accesses the storage unit 140 and controls the display unit 130 to display the e-book content at a preset time point according to the e-book profile 146. As a result, the user may use the e-book easily, conveniently and periodically at a determined geographical location by displaying the e-book automatically as described above. Further, the present invention may provide an alarm effect notifying a start of a program.

Specifically, in step 220, the e-book control unit 165 accesses the e-book profile 146 and determines whether e-book use history information related to an e-book to be displayed exists. The e-book control unit 165 controls to display the e-book according to the e-book use history information. At this time, the e-book control unit 165 may apply various methods for displaying the e-book content. For example, the e-book control unit 165 may control to display on the display unit 130 a page of the e-book that was displayed when entering the previous termination mode according to the internal location information of the e-book, such as a page number, stored in the e-book use history information.

The e-book control unit 165 may control to display a summary of the most recent e-book use history information on a part of the display unit 130, and may control to provide details of the e-book use history information if the displayed summary is selected. The e-book control unit 165 may control the display unit 130 to display a list of stored e-book use history information. The e-book control unit 165 controls the display unit 130 to display the e-book according to internal location information of the e-book stored in step 220 by using the e-book use history information.

After the e-book is displayed, the mobile terminal maintains the use mode until termination of the e-book is selected. The e-book control unit 165 determines whether e-book supplementary information is received during the use mode (222). The e-book control unit 165 may receive e-book supplementary information through various functioning parts during the use mode. For example, the e-book control unit 165 may receive a note input through the input unit 120 during display of the e-book, image received from the wireless communication unit 110, audio, video or electronic documents, audio file of learning contents or meeting contents recorded through a microphone of the audio processing unit 150, and still image and moving image files captured by a camera.

If e-book supplementary information is determined to be received in step 222, the e-book control unit 165 may control to buffer information received using an e-book viewer program or e-book control program in the storage unit 140 (224). The e-book control unit 165 then controls the process to perform step 230. If e-book supplementary information is determined not to be received, the e-book control unit 165 controls the process to perform step 230.

The e-book control unit 165 determines whether to enter a termination mode (230). The entrance to the termination mode of the e-book is determined according to a user's input, and to a set time point or geographical location according to the e-book profile 146. As an example of a case in which the entrance to the termination mode is determined according to a set time point according to the e-book profile 146, if the set time point is reached, the mobile terminal 100 may enter the termination mode under control of the control unit 165. Alternatively, if the e-book is determined by the GPS reception unit 170 to be located outside a geographical location according to the e-book profile 146, the mobile terminal 100 may enter the termination mode.

If the mobile terminal 100 is determined not to enter the termination mode in step 230, the e-book control unit 165 controls to return to step 220 to continue displaying the e-book. If the mobile terminal 100 is determined to enter the termination mode in step 230, the e-book control unit 165 determines whether any buffered e-book supplementary information exists (240). At this time, the e-book control unit 165 may determine by checking buffer of the storage unit 140.

If buffered e-book supplementary information is determined to exist, the e-book control unit 165 controls to perform step 245. The e-book control unit 165 links the buffered e-book supplementary information to e-book profile 146 and stores it (245). At this time, the e-book control unit 165 controls the buffered information to be included in the e-book profile 146 or to be stored separately from the e-book profile 146.

If buffered e-book supplementary information is determined not to exist in step 240, the e-book control unit 165 controls the process to perform step 250. The e-book control unit 165 updates the e-book profile 146 (250). At this time, the e-book control unit 165 determines internal location information of the e-book such as a page number of the e-book that was displayed before entrance to the termination mode, and a time point and geographical location at which the termination mode is entered, and creates new e-book use history information. The e-book control unit 165 then adds newly created e-book use history information to the e-book profile 146, and updates the e-book profile 146.

After updating the e-book profile 146 in step 250, the e-book control unit 165 terminates the e-book (260). The e-book control unit 165 then determines whether to terminate the aforementioned e-book automatic display function (270). Step 270 may be performed according to input from a user. If it is determined that a user does not terminate an e-book automatic display function, the e-book control unit 165 controls to return to step 202 to enter the standby mode.

According to an exemplary embodiment of the present invention, the e-book control unit 165 may control to perform only a function related to the e-book during the use mode of the mobile terminal 100. As an example, the e-book control unit 165 may control to store a specific information received from the outside of the mobile terminal 100 through the wireless communication unit 110 according to setting of the user, so that incoming calls, SMS (Short Message Service) and MMS (Multimedia Messaging Service) can be recorded in a log file in the storage unit 140 so that the user is not interrupted. The stored log file may be displayed on the display unit 130 according to control of the control unit 160 after termination of the e-book. Therefore, the present invention may help the user to concentrate on the e-book during use of the e-book in a class, seminar or meeting.

Note that the above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although exemplary embodiments of the present invention have been described in detail hereinabove, it should be understood that many variations and modifications of the basic inventive concept herein described, which may be apparent to those skilled in the art, will still fall within the spirit and scope of the exemplary embodiments of the present invention as defined in the appended claims and their equivalents.

What is claimed is:

1. A method of displaying the content of an e-book, the method comprising:
displaying the e-book content at a specific set time point specified in an e-book profile,
linking an e-book supplementary information to the e-book profile and storing the e-book supplementary information, and
updating, when the displaying of the e-book content is terminated, the e-book profile to comprise internal location information of the e-book content for a subsequent display.

2. The method of claim 1, further comprising creating and storing, in a registration mode, the e-book profile by linking timetable information comprising the set time point to e-book information comprising the e-book content.

3. The method of claim 2, wherein updating the e-book profile comprises creating, when the display of the e-book content is terminated, e-book use history information comprising the internal location information of the e-book content for the subsequent display and at least one of a time point and a geographical location at which the display of e-book content is terminated.

4. The method of claim 3, wherein displaying the e-book content comprises displaying the e-book content according to the internal location information of the e-book use history information.

5. The method of claim 2, wherein the timetable information further comprises a set geographical location, and displaying the e-book further comprises displaying the e-book at the set time point and the set geographical location according to the e-book profile.

6. The method of claim 1, wherein displaying the e-book content at a specific set time point specified in the e-book profile is performed with reference to a current geographical location identified by a GPS unit.

7. The method of claim 1, wherein the updating the e-book profile comprises storing a page reference displayed prior to the termination.

8. The method of claim 1, further comprising storing incoming information received during an operation to prevent an interruption of the displaying of the e-book content and displaying the incoming information after the displaying the e-book content is terminated.

9. A mobile terminal for displaying the content of an e-book, comprising:
a display unit for displaying the e-book content,
a storage unit for storing e-book information comprising the e-book content, timetable information comprising a set time point and an e-book profile linked to the e-book information and the timetable information, and
a control unit for controlling the display unit to automatically display the e-book content at the set time point according to the e-book profile, to link an e-book supplementary information to the e-book profile and store the e-book supplementary information, and to update, when displaying of the e-book content is terminated, the e-book profile to comprise current internal location information of the e-book content for a subsequent display.

10. The mobile terminal of claim 9, wherein the control unit creates and stores, in a registration mode, the e-book profile by linking the timetable information and the e-book information.

11. The mobile terminal of claim 10, wherein the control unit creates, to update the e-book profile when displaying of the e-book is terminated, by generating e-book use history information comprising the internal location information of the e-book for a subsequent display and at least one of a time point and geographical location.

12. The mobile terminal of claim 11, wherein the control unit controls the display unit to display the e-book content according to the internal location information of the e-book use history information.

13. The mobile terminal of claim 10, further comprising a GPS reception unit to detect a current geographical location, wherein the e-book content is displayed at the set time point when if the current geographical location is identical to a set geographical location in the e-book profile.

14. The mobile terminal of claim 10, wherein the e-book control unit controls to buffer the e-book supplementary information in the storage unit during the displaying of the e-book content.

15. The mobile terminal of claim 9, wherein the control unit stores incoming information received during an operation to prevent an interruption of the displaying of the e-book content and displays the incoming information after the displaying the e-book content is terminated.
